(19) United States
(12) Patent Application Publication
(10) Pub. No.: US 2025/0232117 A1
(43) Pub. Date: Jul. 17, 2025

(54) LARGE LANGUAGE MODEL AUGMENTATION WITH DEFINITE FINITE AUTOMATON

(71) Applicant: NEC Laboratories America, Inc., Princeton, NJ (US)

(72) Inventors: Yiyou Sun, Madison, WI (US); Haifeng Chen, West Windsor, NJ (US)

(21) Appl. No.: 19/015,018

(22) Filed: Jan. 9, 2025

Related U.S. Application Data
(60) Provisional application No. 63/619,883, filed on Jan. 11, 2024.

(51) Int. Cl. G06F 40/289

(52) U.S. Cl. CPC G06F 40/289

(57) ABSTRACT

Systems and methods for tagging a user prompted conversation to generate contextually relevant user tags from a user prompt according to pre-populated tags in a Definite Finite Automaton (DFA) tree, navigating the DFA tree according to tags to determine a user prompted conversation state, accessing dialog identifications of previous conversations that are similar that are associated with the user prompted conversation state, compiling an LLM prompt for forming a response to the user prompted conversation, and generating a response to the user based on the prompt.

### RELATED APPLICATION INFORMATION

This application claims priority to 63/619,883, filed on Jan. 11, 2024, incorporated herein by reference in its entirety.

### BACKGROUND

### Technical Field

The present invention relates to Large Language Models (LLMs) and more particularly a framework to ensure LLMs responses are traceable and relevant.

### Description of the Related Art

Popular LLMs like OpenAI's GPT-3.5 or GPT-4 may generate inappropriate or misleading content unless specially optimized. Fine-tuning these models, while effective, is not always viable due to open-source requirements, the need for intricate design, and the need for substantial data to mitigate overfitting risks. An alternative method, in-context learning (ICL), uses relevant examples to guide LLMs. However, including all training samples in the LLM's context for ICL is impractical.

### SUMMARY

According to an aspect of the present invention, a method is provided for tagging a user prompted conversation to generate contextually relevant user tags from a user prompt according to pre-populated tags in a Definite Finite Automaton (DFA) tree, navigating the DFA tree according to tags to determine a user prompted conversation state, accessing dialog identifications of previous conversations that are similar that are associated with the user prompted conversation state, compiling an LLM prompt for forming a response to the user prompted conversation, and generating a response to the user based on the prompt.

According to another aspect of the present invention, a system is provided for a hardware processor, and a memory that stores a computer program. When executed by the hardware processor, the memory causes the hardware processor to tag a user prompted conversation to generate contextually relevant user tags from a user prompt according to pre-populated tags in a Definite Finite Automaton (DFA) tree, navigate the DFA tree according to tags to determine a user prompted conversation state, access dialog identifications of previous conversations that are similar that are associated with the user prompted conversation state, compile an LLM prompt for forming a response to the user prompted conversation, and generate a response to the user based on the prompt.

According to another aspect of the present invention, a computer program product is provided for a non-transitory computer-readable storage medium containing computer program code, the computer program code when executed by one or more processors causes the one or more processors to perform operations, the computer program code comprising instructions to tag a user prompted conversation to generate contextually relevant user tags from a user prompt according to pre-populated tags in a Definite Finite Automaton (DFA) tree, navigate the DFA tree according to tags to determine a user prompted conversation state, access dialog identifications of previous conversations that are similar that are associated with the user prompted conversation state, compile an LLM prompt for forming a response to the user prompted conversation, and generate a response to the user based on the prompt.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level computing system for a Definite Finite Automaton Large Language Model (DFA-LLM), in accordance with an embodiment of the present invention;

FIG. 2 is a flow diagram illustrating a method for a DFA-LLM, in accordance with an embodiment of the present invention;

FIG. 3 is a workflow illustrating a system for using a DFA-LLM, in accordance with an embodiment of the present invention;

FIG. 4 is pseudocode of a keyword tag tree building algorithm in accordance with an embodiment of the present invention;

FIG. 5 shows a training set with dialog that is subsequently formed into a DFA keyword tree in accordance with an embodiment of the present invention;

FIG. 6 outlines the DFA-based in-context learning (ICL) of FIG. 5 in accordance with an embodiment of the present invention;

FIG. 7 is an example conversation based on FIGS. 5 and 6 in accordance with an embodiment of the present invention; and

FIG. 8 is an exemplary architecture of a system, in accordance with an embodiment of the present invention.

### DETAILED DESCRIPTION OF PREFERRED EMBODIMENTS

In accordance with embodiments of the present invention, systems and methods are provided for a Definite Finite Automaton (DFA) for Large Language Models (LLM).

LLMs traditionally use Retrieval Augmented Generation (RAG) to produce responses to queries. RAG is the process of optimizing the output of a LLM, so the LLM references an authoritative knowledge base outside of its training data sources before generating a response. LLMs are trained on vast volumes of data and use billions of parameters to generate original outputs for tasks like answering questions, translating languages, and completing sentences. RAG extends the already powerful capabilities of LLMs to specific domains or an organization's internal knowledge base, all without the need to retrain the model.

RAG is imperfect, however. One such problem is that RAG relies on uninterpretable embedding spaces. This makes RAG notoriously untrustworthy. Furthermore, RAG treats dialogs as undivided blocks of information. Undivided blocks of information are less precise and are less contextually relevant. This prevents RAG LLMs from accurately and appropriately responding to conversational nuance. RAG LLMs do not have the ability to model a conversation into discrete steps and categorize the user prompt.

A RAG LLM incorporated with Definite Finite Automaton (DFA) does not suffer from these problems. DFA, derived from training data, can be applied to any pre-trained RAG LLM for seamless integration. DFA or data organized from a DFA can be integrated into a RAG LLM or can be agnostic to the RAG LLM. The term LLM may be used interchangeable and/or instead of RAG LLMs.

DFA is useful in industries that prefer human agents to facilitate user interactions such as finance, healthcare, retail, telecom, etc. DFA can be used in a variety of other industries as well. DFA is designed to match a human's response as closely as possible. DFA mimics human-like, pipeline-guided behavior in response generation. This can find utility in instances that require adherence to specific workflows.

For example, in the tele-medicine field DFA can be utilized in LLMs to facilitate better user interactions. Special attention to user diction, syntax, tone, etc. can assist the LLM to serve the user more effectively and efficiently. Alternatively, DFA can converge on supplying complete and accurate responses to queries faster. LLMs trained to assist users with musculoskeletal problems can associate terms such as “dead leg” and “charley horse” or more complex terms like “muscle spasm” as the same. This reduces the LLMs need to learn the term at each inference output.

Incorporating DFA's into LLM's can allow for accurate output generation without the computationally expensive or time intensive aspects of RAG models. The DFA-LLM model can include tagging conversations the LLM is having with a user. According to an embodiment, tagging the conversation can include extracting keyword tags from the conversation. The tagging creates keyword tags that make the user's concepts mirror contextually relevant keyword tags that can be present in a pre-populated DFA tree. According to an embodiment, the DFA tree can be a tree of all the concepts the LLM can encounter in a specific domain. The DFA can also build the DFA tree such that the more commonly used keyword tags are a closer level to the root than less commonly used keyword tags (with respect to levels of the DFA tree). The DFA can merge commonly used keywords tags that are frequently in conversations. The DFA can also merge commonly used keyword tags that are similar concepts in the DFA-tree if the concepts are similar enough to reduce redundancy.

Once the user's text is tagged, the DFA can navigate the DFA tree to compare the tagged keyword tags to the pre-populated tags to determine the state of the conversation. Once a match is found the DFA can access dialog identifications related to the keyword tags. These dialog identifications are similar conversations that the LLM can use to guide the LLM's responses. Using dialog identifications, the LLM can form an internal in-context learning (ICL) prompt, which the user cannot view. The prompt can be used to generate a complete response in the LLM. The LLM uses this complete response as an output which the user can view.

The LLM can use the concepts and implementation of DFA to generate responses. The LLM can use a software package to perform embodiments of the present invention. A user inputs text into the LLM. After the LLM receives the user input, the LLM may execute software that holds instructions for the DFA to monitor the state of the conversation and generate responses accordingly. The monitoring and generating of responses involves the creation and usage of a DFA tree. The DFA software may be separate from the software for creating and using of the DFA tree. Alternatively, the DFA and DFA tree may be the same software.

The DFA tree is a tree data structure containing tags of all the possible conversation topics that LLM can be used for responding. The DFA tree can be created with certain optimizations such as nodes closer to the root are earlier conversation states than nodes closer to leaves. The DFA tree can also be optimized to combine nodes with other nodes that contain the same concept or concept that is sufficiently similar. Also, DFA tree nodes can be combined if the conversation has the possibility of following the same sequence. For example, a portion of a conversation that may have the LLM asking for a review may also give appreciation of using the LLM and so the DFA tree may combine nodes to this effect. After the LLM receives the user text, the LLM may convert the text into keyword tags affiliated with the relevant DFA tree node values and the LLM may form an ILC prompt.

The ILC prompt may be a separate software package. The ICL prompt may be internal to the LLM. In some embodiments, the user may never view the LLM ILC prompt. In some embodiments, the ILC prompt may be output with the generated response. The ILC prompt may allow the user to verify that the LLM is correctly generating the response to the input by allowing the user to see if the keyword tags are relevant. The user may enter a new input to achieve more accurate keyword tags if necessary. The ILC prompt may be used to allow the LLM to form the generated response. The software package that generates the response may be separate from the DFA, DFA tree, and ICL prompt or the may be included in the same software package. The LLM may determine conversation states by mapping keyword tags to DFA tree nodes which may have known conversation states and prior conversation information such as prior conversation states.

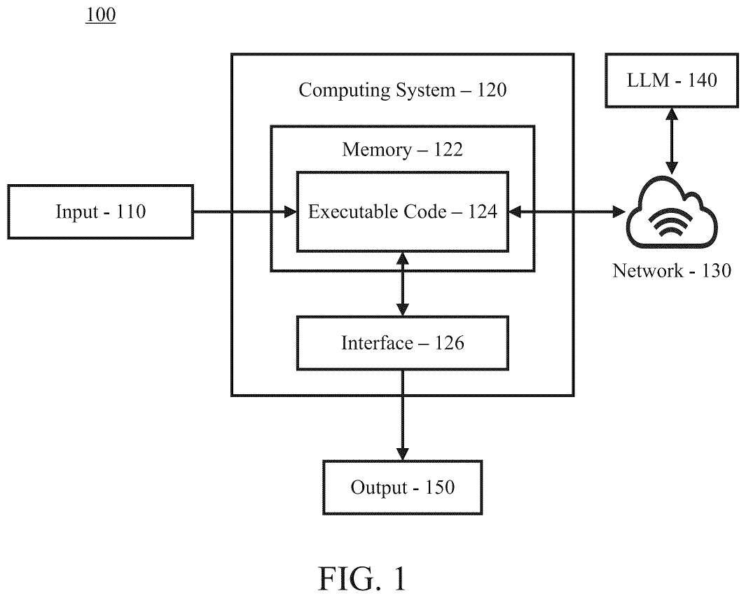

Referring now in detail to the figures in which like numerals represent the same or similar elements and initially to FIG. 1, a system for computing an LLM's 140 uncertainty is shown. System 100 includes an input 110 which is received by computing system 120. Computing system 120 includes memory 122 and interface 126. Memory 122 has executable code 124 which can identify, tag, and categorize keywords from the input. Executable code 124 can also communicate with network 130. Network 130 can communicate between executable code 124 and LLM 140.

An output 150 can be produced based on an internal prompt formed in the executable code 124 which includes keywords characterizing the input 110.

LLM 140 receives input 110, applies Natural Language Processing (NLP) on the data contained within the input 110, and generates output 150 in accordance with data LLM 140 has learned from and LLM parameters. The data LLM 140 can train on and can include pre-inference training and ICL such as few-shot learning demonstrations. LLM 140 may have specific LLM parameters which include algorithms dictating the procedure LLM 140 follows when generating output 150, according to some embodiments. Other forms of machine learning for character and word processing are contemplated such as OCR and CNN.

ICL can be advantageous to pre-inference learning in some instances. ICL can be less computationally intensive than pre-inference learning and does not require persistently stored information (and therefore ensures stability in model parameters). Few-shot learning, one-shot learning, and zero-shot learning are several types of ICL that can be used to train the DFA-LLM.

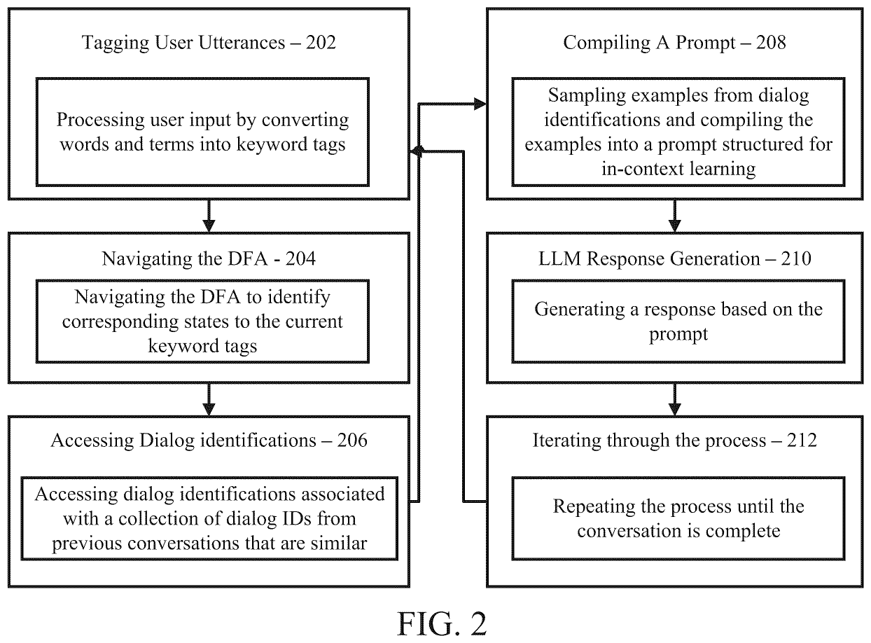

Now referring to FIG. 2, a flow chart of the process of employing DFA when generating output 150 (FIG. 1) is shown and described. The actions involved in the DFA's integration into the LLM include tagging user utterances 202, navigating the DFA 204, accessing dialog identifications 206, compiling a prompt 208 for LLM 140 (FIG. 1), generating LLM response 210, and repeating the process 212. Tagging user utterances 202 further includes having LLM 140 (FIG. 1) receive input 110 (FIG. 2) and assign keyword tags. This process of tagging keywords mirrors tagging that occurs in the training phrase of LLM 140 (FIG. 1). The keyword tags describe conversational elements that can be extracted from the user input 110 (FIG. 1). Keyword tags can be determined by selecting LLM parameters that can generate a list of concise and relevant keywords for the conversation's content.

The LLM parameters are structured to adhere to two criteria when assigning keyword tags, brevity and focus on core elements. Brevity can be achieved, in some embodiments, by limiting keyword tag generation to a set number of words per keyword tag. For example, the number of words for each keyword tag can be limited to three words. In other embodiments, this number can be greater or less. The focus on core elements can be achieved by concentrating on actual events, issues, queries, or solutions present in the conversation. Focusing on core elements may necessitate more interaction with the user to achieve answers related to actual events, etc. For example, further clarification or additional details may be required by the user.

Navigating the DFA 204 further includes navigating through the DFA to identify a corresponding conversational state based on the keywords. Conversations can have states, including in some embodiments, a beginning, a middle, and an end. Other embodiments may have more states or more sophisticated states. These states can be mapped to certain keyword tags such as “#hello” and “#thanks.” In some embodiments keyword tags like “#also” can indicate a beginning state even though other keyword tags indicate the conversation is at an end state (e.g., when the user is entering another query once the first is completed).

Accessing dialog identifications 206 further includes accessing a collection of dialog identifications, [symbol] (q), which represent past conversations that have followed a [symbol] similar form. Accessing past conversations may also include recording and tracing past conversations such that the conversation can assist in ICL.

Compiling a prompt 208 further includes compiling sample examples from the dialog identifications into a prompt form which can use ICL to generate outputs 150 (FIG. 1). Generating LLM response 210 further includes generating a response based on the given prompt generated by compiling a prompt 208. Repeating the process 212 further includes repeating the previous portions of the process (202-210) until a stopping criteria, such as the final state, is reached.

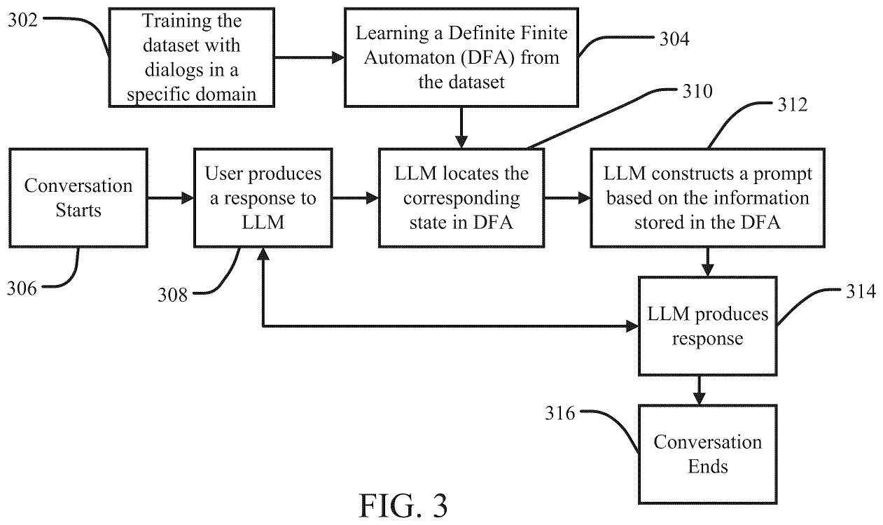

Now referring to FIG. 3, a workflow of the process employing DFA during a conversation with LLM 140 (FIG. 1) is shown and described. The workflow can be classified in two portions, the pre-processing stage and inference stage. The pre-processing stage includes block 302 and block 304. Block 302 is related to training a dataset with dialog in a specific domain. The specific domains can include healthcare, finance, retail, and telecommunications, and technical assistance, etc. The datasets can include jargon used in the specific domain. In some embodiments the dataset can be a complete list of all the jargon used in the specific domain, in other embodiments the dataset can include the most common jargon in the specific domain. In even more embodiments, these datasets can include several words and terms referring to the same concept. Furthermore, various keyword tags can be directed to the same concept.

For example, in the specific domain of cell phone troubleshooting the phrases “my phone dies quickly” and “battery has a low capacity” do not have any words in common, yet the two phrases are directed towards the same problem. “Died” in the context of technology usually means no power in a device to allow the device to function properly. “Low capacity” is directed towards the same concept as “phone dies.” The keyword tags for these problems can be “#issue” and “#battery.” In another example, the words “display” and “screen” both refer to user interface yet do not have a common origin or etymological root. The keyword tag for these terms can be “#UIUX.” In other embodiments, the words “music won't play” may be associated with both keyword tags “#issue #hardware #speaker” and “#issue #settings.”

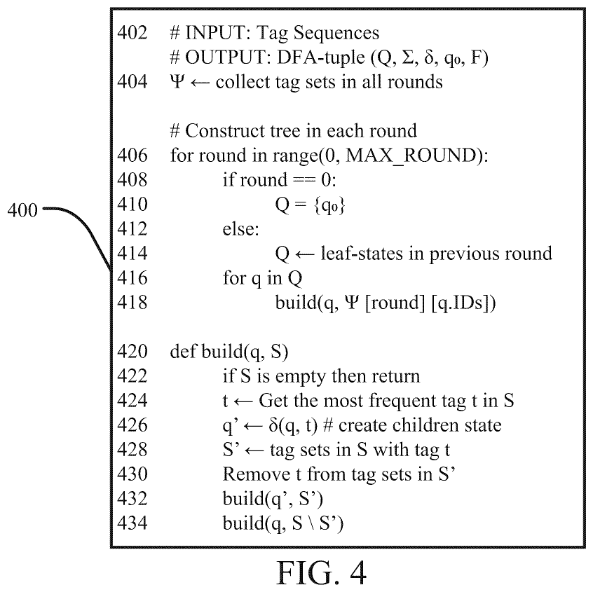

Block 304 is related to learning the DFA from the dataset. Learning the DFA includes accurately identifying and extracting relevant keyword tags. Learning the DFA further includes building a tree of keyword tags and merging tree leaves to reduce redundancy in the tree. This process is further described in FIGS. 4-7.

The inference stage includes block 306. Block 306 further includes starting a conversation with LLM 140 (FIG. 1). The conversation can be started with input 110 (FIG. 1) such as a question or statement. In some embodiments the question and statement can serve the same purpose. For example, in the specific domain of telemedicine the queries “why does my stomach hurt” and “my stomach hurts” can be treated the same by the LLM 140 (FIG. 1). These are queries to identify the cause of the issue and produce suggestions for the issue in the form of output 150 (FIG. 1).

Block 308 includes having a user produce a response to LLM 140 (FIG. 1) output 150 (FIG. 1). Both the response by the LLM 140 (FIG. 1) and response by the user progress the conversation toward the conversation's next state.

Block 310 includes having the LLM 140 (FIG. 1) locate a corresponding state of the DFA to the conversation. The states of the conversation can go out of order, skip states, or revert to prior states. In an embodiment, the conversation can have a beginning, such as pleasantries and introductions, a problem-solving portion, and a conclusion. The introductions can indicate the capabilities and limitations of the LLM 140 (FIG. 1). The problem-solving phase can include identification of the issue and proposing solutions to the issue. The problem solving phase can also include indicating further limitations or restrictions, making some solutions untenable or others preferred. The conclusion phase can include ensuring all issues are resolved and no matters are outstanding.

LLM 140 (FIG. 1) can locate conversation states corresponding in the DFA based on language used and other context user tone. Other aspects of user response are also contemplated, for example, emotion. In other embodiments other indicators are also contemplated such as metadata, e.g., timeliness of user response. Block 310 can use learned information from the pre-processing stage. Specifically, block 310 can apply information from block 304.

Block 312 includes having LLM 140 (FIG. 1) construct a prompt based on the information stored in DFA. The prompt is internal and simplifies the user query for generating output 150 (FIG. 1). The process from blocks 306 to block 316 can be repeated any number of times until the user is satisfied with the response or decides to stop responding.

Now referring to FIG. 4, pseudocode for building a keyword tag tree is shown. The keyword tag tree is traversed by the DFA to generate responses. The pseudocode of FIG. 4 is Python-style. Other programmable styles are contemplated. Algorithm 400 can build a DFA-tree. The DFA-tree prioritizes having more frequently used keyword tags at a level closer to the root than less frequently used keyword tags. Algorithm 400 employs nested loops and recursive functions, however other techniques may also be used in other embodiments. Line 402 includes comments regarding variables that affect the function described herein and the generated response of the tree built in the algorithm 400. The variables can include keyword tag sequences. The generated response can be a DFA-tuple tree according. In an embodiment, the generated response can be specified as a tuple defined by the variables (Q, Σ, δ, q₀, F). Other data structures and variables are also contemplated.

DFAs prefer simple inputs. Complexity and conversational elements used by users are difficult to implement into a DFA directly. Using layers of abstraction retains the complexity and conversational elements in the DFA-LLM while simplifying the text the DFA is processing to make the conversation more manageable to correspond with. Using the keywords tags encapsulate the core concepts of an LLM input 110 (FIG. 1) can create this abstraction.

The DFA's tuple can be governed by the factors, Q, Σ, δ, q₀, F, which generate a response to the user. Q can be a finite set of states. These states can be parts of a conversation like initiation of a conversation, a query about a specific issue, a response, or the conclusion of the interaction. Σ, can be a finite input alphabet. The alphabet can be a complete repository of keywords that describe all the possible utterances of the LLM input 110 (FIG. 1) with a degree of abstraction. This repository can include one or more specific domains. δ (defined as Q×Σ→Q), can be a transition function. The transition function maps a state and a tag to a subsequent state. q₀, wherein q₀∈Q, can be a start state. F, wherein F⊆Q can be a set of accept states. Accept states are states indicating the completion of a conversation. The DFA processes a string of symbols from Σ and changes the conversation's state according to the transition function δ. The string is accepted by the DFA if, after processing all symbols, the automaton is in one of the accept states in F.

Line 404 stores variables of the identified keyword tag sets across multiple rounds of several conversations. For example, during a conversation with a chatbot assisting the user with a cellular phone's battery issues, keyword tags in round one of a conversation can include “#keyboard, #issue,” “#issue, #battery,” or “#update.” Using only a few words, the DFA can learn a lot of information about the query. The second round of the conversation can include “#link.” This can be a link to a relevant webpage or other source that will serve the query. Regardless of the type of link provided, all are categorized the same for conversation keyword tagging purposes. In other words, every conversation in this specific domain, according to an embodiment, will eventually lead to the user receiving a link for more information. The third round of the conversation can include “#thank.” Additional rounds can occur depending on the complexity of the issue such as information gathering and more troubleshooting. In line 402, the keyword tags can be grouped by conversation and in line 404, the keyword tags can be grouped by round.

Keyword tagging can include several other rules to ensure efficient keyword list generation. One of the rules can be that words appearing with higher frequency can be placed earlier in the sequence than words appearing with less frequency. This is a design choice selected when the order of keywords in an input is ambiguous. This design choice may help in keyword tag tree generation and traversal. Additionally, for each subsequent state, a newly constructed leaf from the keyword tag tree, the state becomes a child state of one of the leaf states from the previous round's tree. The selection of leaf states, Q, for progression into the next round is guided by additional heuristic rules. This is a design choice selected because different states of the conversation can have different keywords.

The portions of the algorithm 400 between line 406 and line 418 construct the keyword tag tree in each round of the conversation. In some embodiments the algorithm 400 between line 406 and line 418 can include nested loops. The outer loop can ensure the tree has enough levels to correspond with the number of conversation states. The inner loop calls a function to build the keyword tag tree. The inner loop is described in line 416 and line 418. Line 408 sets a condition, such that the first iteration of the outer loop line 410 is executed. Line 410 states the finite set of states is equal to the start state. Line 412 is the alternative of the condition set in line 408 and states that line 414 is executed. Line 414 states that the finite set of states is the leaf-states from the previous round.

Between line 420 and line 434 further describes building the keyword tag tree. As described herein, the guiding strategy for building the keyword tag tree can be selecting the most frequent tag to expand the tree first. In some embodiments the algorithm 400 for building the keyword tag tree can be recursive. Line 422 is a return function to exit the recursive function if the DFA tree node is empty. Line 424 can assign a variable for the most common keyword tag. For example, a value, “t,” that is the variable for the most common keyword tag, can have a keyword tag of “#issue.” Line 426 can allow for the creation of children states by preserving the current state. Line 426 is initially the start state, q₀. Line 428 tags sets with the keyword tag defined in line 424, the most common keyword tag from the set. The keyword tag “#issue” may indicate that an issue exists, and further keyword tags may indicate the specific feature the issue is directed towards. The inclusion of these keyword tags can change the state of the conversation. Line 430 may remove the most common keyword tag from the data structure formed in line 428. Line 430 can remove “#issue” from keyword tag sets as one way to differentiate between different types of issues within the keyword tag tree and move on to other tags in the alphabet. Line 432 can recursively call the function in line 420 with the variables updated in line 426 and line 428. The new keyword tags tree can have several layers without repeating keywords in any two leaves. Line 434 can build another tree after line 432 which incorporates the initial state q₀ instead of the new state updated in line 426. This can allow the keyword tag tree to incorporate values not within the branch the function is currently building.

In some embodiments, the DFA can maintain a record where each state's indices of dialogs have been traversed through. This is achieved by following the trajectory of the tag sequences as the conversation progresses. Formally, this tracking is represented by the function I(q₀), which maps state q to a set of dialog identifications in {1 . . . , N}. This enables the DFA to trace back and identify the most relevant dialog samples that can be effectively utilized in ICL.

The algorithm 400 can also merge leaves if the leaves are repetitive, redundant, or unnecessary. In some embodiments, every conversation will provide a link and a thank you note from the LLM 140 (FIG. 1). These can be merged from all the final leaves on each branch because these portions of the conversation will always occur in this specific domain.

Once the keyword tree is generated, analogous but linguistically different terms can be merged. This can be done based upon conversational context. In some embodiments, to merge keyword tree tags, a similarity score can be used. The similarity score, ϕₛᵢₘ(q, q′), can be defined as

$${ϕ}_{sim} ( q , {q}^{′} ) = \frac{{\sum }_{a} b \cdot c}{{\sum }_{d} f \cdot {\sum }_{g} h} ,$$

where a is defined as a=t∈ [symbol] (q)∩ [symbol] (q′), b is defined as b=| [symbol] (δ(q, t))|, c is defined as c=| [symbol] (δ(q′, t))|, d is defined as d=t∈ [symbol] (q), f is defined as f=| [symbol] (δ(q, t))|, g is defined as g=t∈ [symbol] (q′), and h is defined as h=| [symbol] (δ(q′, t))|. [symbol] is further defined as the tag sets connected to q: [symbol] (q)={t∈Σ|∃q′∈Q, δ(q, t)=q′}.

The similarity score, (ϕₛᵢₘ(q, q′), calculates the ratio of common tags connected to both conversation states, q and q′. The significance of each tag is considered by counting the number of dialogs related to the connected state, denoted by [symbol] (δ(q, t)). This approach focuses on comparing the immediate (1-hop) children states. Once the similarity score is calculated, a threshold λ is set to determine which node pairs should be merged. Pairs with a similarity score exceeding the threshold, ϕₛᵢₘ(q, q′)>λ, are considered for merging.

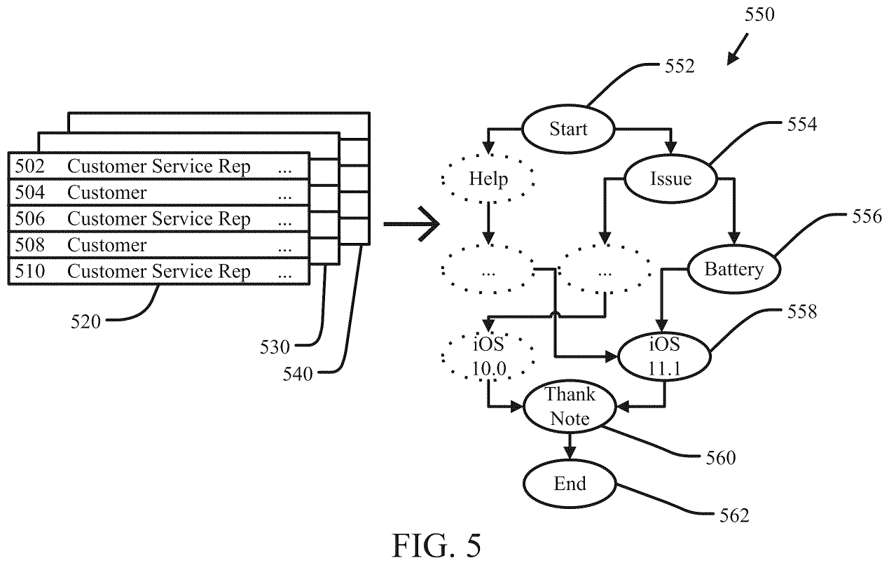

Now referring to FIGS. 5-7, illustrations of the DFA-LLM framework are depicted as shown. FIG. 5 shows a training set with dialog that is subsequently formed into a DFA keyword tree. Conversation lines 502, 504, 506, 508, 510 are responses between a user and LLM 140 (FIG. 1) in conversation 520. Conversation lines 502, 506, 508 are by LLM 140 (FIG. 1) and are conversing with the user. The user responds with conversation lines 504, 508. Conversation 520 then is converted into DFA keyword tags along with conversations 530 540 to form a keyword tag tree 550.

Keyword tag tree 550 has nodes that correspond to each state of conversations 520 530 540. Keyword tag node 552 initiates the conversation 520 (e.g., conversation line 502). Using NLP or other techniques known in the art the conversation line 504 can be interpreted in response to conversation line 502. Other techniques can include a convolutional neural network (CNN), ocular character recognition (OCR), etc. Conversation line 504 can correspond to keyword tag node 554. For example, the keyword tag in keyword tag node 554 can be “#issue” rather than “#help.” A child node to “#issue” in keyword tag node 554 may be further specified. Keyword tag node 556 can identify the aspect that requires assistance with more particularity. For example, keyword tag node 556 can include “#battery.” This is opposed to other aspects that may require assistance such as “#camera,” or “#internet reception.”

Conversation line 506 can further inquiry into the problem to better assist the LLM 140 (FIG. 1) to identify how to respond to the user. Conversation line 506 may include a question directed towards the operating system of the device which is not operating correctly. The user may provide an answer in conversation line 508. Keyword tag nodes 552, 554, 556, 558 can be various information gathering and problem-solving states. In reply, conversation line 560 may provide a solution or link to a solution meaning the query is complete. Conversation line 560 can also thank the user. Conversation line 562 can be an end state. Conversation line 560 and conversation line 562 can be merged as a single result. Conversations 530, 540 can recite similar conversations and complete the keyword tag tree 550.

The DFA tree and the DFA tree construction can be agnostic to the incorporation into the RAG LLM. The DFA tree and the DFA tree construction can also be incorporated into the RAG LLM. The concepts are separate and related. The DFA tree can facilitate easier navigation and tracking of conversational states which allows for easier conversational responses.

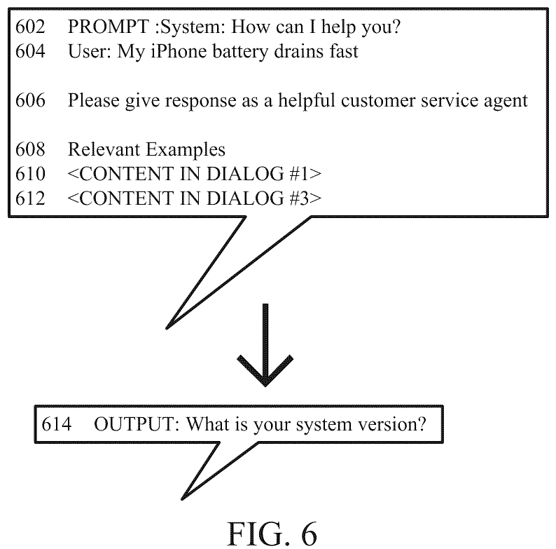

FIG. 6 outlines the DFA-based in-context learning described in FIG. 5. Here, contextually relevant responses are formed based on the conversations 520, 530, 540 (FIG. 5) and keyword tag tree 550 (FIG. 5). Line 602 is a prompt that is sent to users. Line 602 can be generic or more targeted. Line 602 can be target by learning the tendencies of the user and the context. Line 602 correlates to keyword tag node 552. Line 604 is a response by the user. Line 604 correlates to keyword tag node 554 and keyword tag nodes 556. Line 606 is internal. In other words, the user cannot view line 606. Line 608 is a title for clarity purposes. Line 610 and line 612 are relevant examples for the LLM 140 (FIG. 1) Like line 606, line 610 and line 612 are not viewable by the user. Line 610 and line 612 correlate to computing that would be executed between keyword tag node 556 and keyword tag node 558.

Line 614 is generated based on the context derived from the ICL. The DFA can track the conversation as described herein and recognize that more context is necessary to adequately provide a useful response. Line 614 is a question directed towards clarifying the user's problem and the surrounding circumstances.

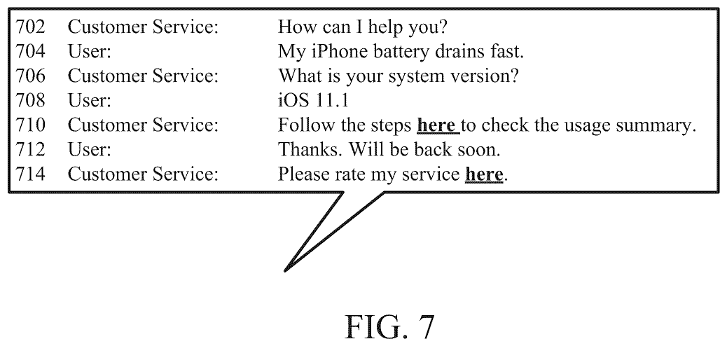

FIG. 7 is an example conversation based on FIGS. 5 and 6. Line 702 is a prompt that begins the interaction. Line 704 is the user's first attempt to describe the issue that the user is seeking to solve. The DFA-LLM needs more specificity to add keyword tags. This is necessary so that DFA-LLM can identify resources applicable to the present issue. Line 706 is the second prompt more directed towards the additional information necessary to produce an appropriate response. Line 708 is the user's additional information requested by the DFA-LLM. Line 710 is the DFA-LLM's final substantive response, included is a link to further help the user. Line 712 and line 714 are formalities to achieve the final conversation states.

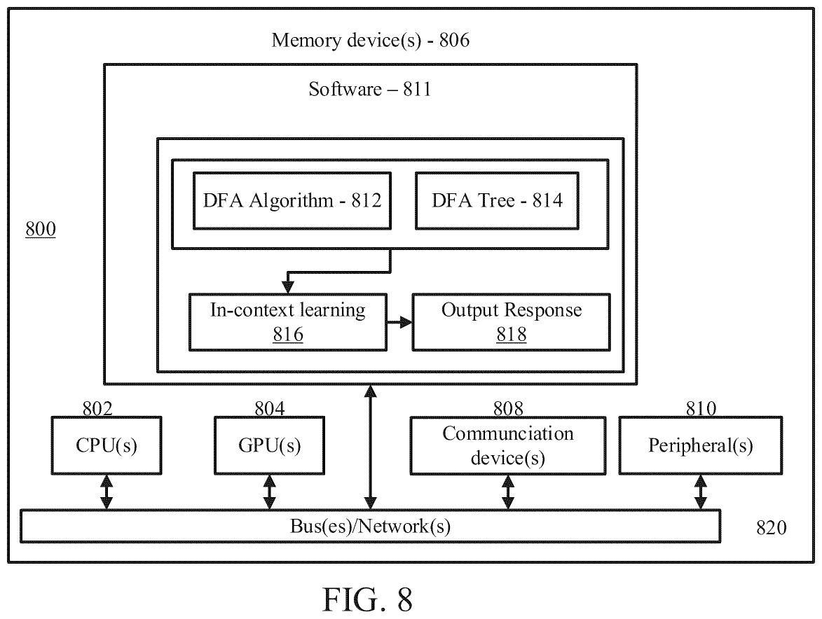

Now referring to FIG. 8 which is an exemplary architecture of a system 800, in accordance with an embodiment of the present invention. The system 800 includes a set of processing units (e.g., CPUs) 802, a set of GPUs 804, a set of memory devices 806, a set of communication devices 808, and a set of peripherals 810. The CPUs 802 can be single or multi-core CPUs. The GPUs 804 can be single or multi-core GPUs. The one or more memory devices 806 can include caches, RAMs, ROMs, and other memories (flash, optical, magnetic, etc.). The communication devices 808 can include wireless and/or wired communication devices (e.g., network (e.g., WIFI, etc.) adapters, etc.). The peripherals 810 can include a display device, a user input device, a printer, an imaging device, and so forth. Elements of system 800 are connected by one or more buses or networks (collectively denoted by the figure reference numeral 820).

In an embodiment, memory devices 806 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 806 store software 811 for implementing one or more of the following: use a DFA algorithm 812, form a DFA tree 814 to categorize inputs into keywords tags, use the DFA algorithm and DFA tree to produce an in-context learning prompt 816, and produce outputs 818 according to the in-context learning prompt. Although FIG. 8 illustrates the software 811 including DFA algorithm 812, DFA tree 814, in-context learning 816, and output 818 these can be packages in any combination or alone.

Of course, the system 800 may also include other elements (not shown), as readily contemplated by one of skill in the art, as well as omit certain elements. For example, various other input devices and/or output devices can be included in system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the system 800 are readily contemplated by one of ordinary skill in the art given the teachings of the present invention provided herein.

Moreover, it is to be appreciated that various figures as described herein with respect to various elements and steps relating to the present invention that may be implemented, in whole or in part, by one or more of the elements of system 800.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method comprising:
tagging a user prompted conversation to generate contextually relevant user tags from a user prompt according to pre-populated tags in a Definite Finite Automaton (DFA) tree;
navigating the DFA tree according to tags to determine a user prompted conversation state;
accessing dialog identifications of previous conversations that are similar that are associated with the user prompted conversation state;
compiling an LLM prompt for forming a response to the user prompted conversation; and
generating a response to the user based on the prompt.

2. The computer implemented method of claim 1, wherein the LLM prompt is formed using in-context learning from the dialog identifications.

3. The computer implemented method of claim 1, wherein the DFA tree merges tree nodes that have a similarity score, ϕₛᵢₘ(q, q′), exceeding a threshold, λ, wherein q is the node is question and q′ is the node q is being compared with.

4. The computer implemented method of claim 1, wherein the conversation's state is determined by δ (Q, Σ), where Q is a finite set of states and Σ is a finite input alphabet.

5. The computer implemented method of claim 1, wherein the DFA tree tracks progress of the conversation using an index tracking function, I(q₀) wherein I(q₀) maps a state q to a set of dialog identifications in {1 . . . , N}.

6. The computer implemented method of claim 1, wherein the DFA tree merges linguistically different but contextually equivalent tags.

7. The computer implemented method of claim 1, wherein the pre-populated tags in a DFA tree include a complete repository of keywords that describe all possible utterances of an LLM input with a degree of abstraction.

8. The computer implemented method of claim 1, wherein the tagging generates no more than three words per tag.

9. A system, comprising:
a hardware processor; and
a memory that stores a computer program which, when executed by the hardware processor, causes the hardware processor to:
tag a user prompted conversation to generate contextually relevant user tags from a user prompt according to pre-populated tags in a Definite Finite Automaton (DFA) tree;
navigate the DFA tree according to tags to determine a user prompted conversation state;
access dialog identifications of previous conversations that are similar that are associated with the user prompted conversation state;
compile an LLM prompt for forming a response to the user prompted conversation; and
generate a response to the user based on the prompt.

10. The system of claim 9, wherein the LLM prompt is formed using in-context learning from the dialog identifications.

11. The system of claim 9, wherein the DFA tree merges tree nodes that have a similarity score, ϕₛᵢₘ(q, q′), exceeding a threshold, λ, wherein q is the node is question and q′ is the node q is being compared with.

12. The system of claim 9, wherein the conversation's state is determined by δ (Q, Σ), where Q is a finite set of states and Σ is a finite input alphabet.

13. The system of claim 9, wherein the DFA tree tracks progress of the conversation using an index tracking function, I(q₀) wherein I(q₀) maps a state q to a set of dialog identifications in {1 . . . , N}.

14. The system of claim 9, wherein the DFA tree merges linguistically different but contextually equivalent tags.

15. A computer program product comprising a non-transitory computer-readable storage medium containing computer program code, the computer program code when executed by one or more processors causes the one or more processors to perform operations, the computer program code comprising instructions to:
tag a user prompted conversation to generate contextually relevant user tags from a user prompt according to pre-populated tags in a Definite Finite Automaton (DFA) tree;
navigate the DFA tree according to tags to determine a user prompted conversation state;
access dialog identifications of previous conversations that are similar that are associated with the user prompted conversation state;
compile an LLM prompt for forming a response to the user prompted conversation; and
generate a response to the user based on the prompt.

16. The computer program product of claim 15, wherein the LLM prompt is formed using in-context learning from the dialog identifications.

17. The computer program product of claim 15, wherein the DFA tree merges tree nodes that have a similarity score, ϕₛᵢₘ(q, q′), exceeding a threshold, λ, wherein q is the node is question and q′ is the node q is being compared with.

18. The computer program product of claim 15, wherein the conversation's state is determined by δ (Q, Σ), where Q is a finite set of states and Σ0 is a finite input alphabet.

19. The computer program product of claim 15, wherein the DFA tree tracks progress of the conversation using an index tracking function, I(q₀) wherein I(q₀) maps a state q to a set of dialog identifications in {1 . . . , N}.

20. The computer program product of claim 15, wherein the DFA tree merges linguistically different but contextually equivalent tags.
